(19) United States
(12) Patent Application Publication
(10) Pub. No.: US 2016/0319960 A1
(43) Pub. Date: Nov. 3, 2016

(54) PIPE SUPPORT AND METHOD FOR SUPPORTING AND ORIENTATING A PIPE

(71) Applicant: Gareth Mark Allen, Port Fairy (AU)

(72) Inventor: Gareth Mark Allen, Port Fairy (AU)

(21) Appl. No.: 15/142,927

(22) Filed: Apr. 29, 2016

(30) Foreign Application Priority Data
Apr. 30, 2015 (AU) 2015901541

(51) Int. Cl. F16L 1/06; F16L 1/028

(52) U.S. Cl. CPC F16L 1/06; F16L 1/028

(57) ABSTRACT

A pipe support is disclosed comprising a peg having a ground engaging formation for insertion into the ground and a striking formation for striking the peg. It also includes an offset pipe holder mounted on the peg. The pipe holder includes a curvilinear pipe engaging formation that is configured to complement a pipe of a predetermined diameter for snugly receiving the pipe therein. The pipe support further includes at least one pipe adapter that is removably mountable on the pipe holder and that is configured to hold a pipe of smaller diameter.

### CROSS-REFERENCE TO RELATED APPLICATIONS

The present application claims the benefit of the filing date of Australian Provisional Patent Application No. 2015901541 filed Apr. 30, 2015, the disclosure of which is hereby incorporated herein by reference.

### FIELD OF INVENTION

This disclosure relates to a pipe support.

The disclosure also relates to a method for lining up pipes in a straight line with a predetermined gradient or fall. The disclosure also relates to a system for lining up pipes in a trench with a fall or slope. It also extends to a pipe installation including the pipe supports.

This disclosure relates particularly, but not exclusively, to a system and method for supporting a subterranean pipe that is received within the ground in plumbing applications, e.g. a waste water pipe for draining waste water from a building to a sewerage main, e.g. for a detached building. It will therefore be convenient to hereinafter describe the disclosure with reference to this example application. However at the same time it must be recognized that the disclosure is capable of broader application. For example the disclosure is not limited to subterranean pipes and could also be used for above ground pipe systems. It could also be used for pipes conveying liquids other than water, or even gases. By way of example the disclosure also applies to pipes conveying hydrocarbon liquids and gases.

### DEFINITION

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

### BACKGROUND OF THE INVENTION

Sometimes plumbing pipes are laid in the ground and are called subterranean pipes. These pipes typically comprise a plurality of discrete pipe sections that are coupled end to end in series. In order to comply with plumbing standards and best practice the pipe sections extend in a straight line along a length of the pipe. It is also important that pipes carrying liquids are arranged with a certain amount of gradient or slope or fall, e.g. a predetermined amount of fall corresponding to a plumbing standard. The slope encourages a gravitational flow of liquid, e.g. water, in a direction of flow of the pipe and avoids pooling of liquid at intermediate points along the length of the pipe. These design considerations are applied in many plumbing applications but they are particularly important in relation to waste water pipes that extend from plumbing fittings and fixtures, e.g. in a building, to a sewerage main.

However there can be difficulties in meeting these requirements when laying pipes in the ground. For example it can be difficult to line up or set up the discrete pipe sections in an excavated trench in a straight line and arranged with the requisite fall. If the pipe sections are supported on a floor of the excavated trench the set up and positioning of the pipes can be very rough and approximate. As a result it can be difficult to lay out the pipe sections with any sort of accuracy in the initial setup aside from the risks of the pipe sections being disturbed later on.

One prior technique of which the applicant is aware is to simply create a required grade along the bottom of the trench and then lay the pipes on the trench floor. This technique is difficult and often leads to variable slope along the pipeline. Furthermore, simply using the bottom of the trench without any form of anchoring or holding is liable to cause the pipe to move during the back filling process and/or bedding process.

Further it can also be difficult to hold the pipes in the correct position while work is being done, e.g. while solvent welding the pipe sections to each other and also while laying bedding materials around the pipe. For example it is very easy for pipe sections to be bumped and displaced during this process and very often there is no reference point or setting showing the correct position to enable the plumber or pipe layer to reposition the dislodged pipe.

It can also be difficult to keep the pipe sections in their set position while backfilling the pipe. For example back filling involves laying a bedding on top of the laid pipe. This naturally applies some forces to the pipe and can disturb the pipe and change its position. For example it can move it down and it can also move it laterally.

Applicant is aware of some prior pipe supports that have been used to place or set pipe sections in their correct position in a trench. These prior pipe supports have typically been manufactured on site, often from spare building materials or metal. One disadvantage with such pipe supports is that they do not grip the pipe, which leads to the pipe not being held substantially in position during a pipe installation process. This may allow the pipe to move thus creating a different slope or grade in the pipeline in various locations. Another disadvantage, with manufacturing pipe supports from metal, is that they are expensive.

Very often these expensive prior supports have to be removed or recovered before the trench is backfilled. That is, because they are expensive to produce it is an economic necessity to recover them from the trench for re-use. This in itself can disturb the pipe from a correct position in which it has carefully been placed. Further after the pipe supports have been removed, the pipe is then not held in position. During a backfilling process when the trench is filled with bedding the pipe is exposed to significant external forces that have the potential to displace it in several directions. However there is no longer a pipe support in place holding the pipe securely in position. This is a severe limitation of these pipe supports.

As a result many subterranean pipes that are laid by plumbers do not extend in a straight line and do not have the predetermined or design level of fall along their entire lengths. This leads to sections of the pipe that are horizontal or have reverse fall and which tends to cause pooling of water. This can have adverse effects, e.g. in terms of developments of harmful agents and odor.

### SUMMARY OF THE DISCLOSURE

Applicant has recognized that it would be advantageous if a technique could be developed that ameliorated the shortcomings of the prior art methods discussed above.

According to an aspect of the disclosure there is provided a pipe support for use in supporting a pipe, comprising:

a peg having a ground engaging formation for insertion into the ground to anchor the support and a striking formation for driving the peg into the ground; and

a pipe holder mounted on the peg that is offset from the peg, the pipe holder including a pipe engaging formation that is configured to engage a pipe in a way that holds the pipe in the pipe holder while permitting the pipe to slide and rotate relative to the pipe holder.

The peg may have an axis that extends between the ground engaging formation and the striking formation, and the striking formation may be formed by an upper end of the peg. The pipe holder may project away from the peg transverse to the axis and may have front and rear major faces.

The pipe engaging formation may be curvilinear and may be configured to complement a pipe of a predetermined diameter for receiving the pipe therein, e.g. snugly.

The pipe engaging formation may be resiliently flexible and may comprise two arcuate forms that extend upwardly to terminal ends that are spaced apart from each other, and the arcuate forms can be flexed to enable a pipe to be passed between their terminal ends to receive the pipe. For example the two arcuate forms may be two upwardly extending arms.

The two arcuate forms may extend through more than a full semi-circle or a half circle and may angle towards each other at their terminal ends for providing actual retention of a pipe engaged with the pipe engaging formation (in addition to support). That is the arcuate forms extend through more than 180 degrees and may be C-shaped.

The pipe support may further include at least one pipe adapter that is removably mountable on the pipe holder. The pipe adapter may be configured to hold a pipe of smaller diameter than a pipe of said predetermined diameter (which is sized to fit in the pipe holder) whereby to render a single pipe support capable of supporting more than one size of pipe.

The pipe adapter may further include an adapter mounting formation for releasably mounting the adapter on the pipe holder. The adapter may further include an adapter pipe engaging formation that is configured to complement a pipe of smaller diameter than the pipe sized to be held by said one pipe engaging formation on the pipe holder.

The pipe support may include a releasable attachment arrangement for releasably mounting said adapter mounting formation on said pipe engaging formation.

The releasable attachment arrangement may comprise complementary clip formations on each of the pipe engaging formation and the adapter mounting formation.

The complementary clip formations may comprise two spaced male formations on the adapter mounting formation and two complementary female formations on said pipe engaging formation on the pipe holder.

The pipe support may include a first pipe adapter sized for receiving a 80 mm pipe, a second pipe adapter sized to receive a 65 mm pipe or a third pipe adapter sized to receive a 50 mm pipe, whereby to enable the pipe holder to be capable of holding pipes having different diameters.

The pipe support may include at least one string locating formation for locating a string thereon that is used to position and orientate the pipe in the pipe holder for lining up a plurality of pipes, e.g. for lining the pipe up with other pipes at a certain gradient.

The pipe support may include a first string locating formation located on the peg above the pipe holder.

The first string locating formation may comprise a tab projecting laterally away from the peg defining a notch through which the string can be passed. Further the pipe holder may be positioned on one side of the peg and the tab may be positioned on an opposite side of the peg.

The pipe support may include a second string locating formation located on the pipe holder, for locating a string used for setting up and aligning pipe sections in a pipe.

The second string locating formation may comprise at least one notch or recess that is substantially centrally positioned on the pipe engagement formation.

While the support provides two distinct string locating formations typically only one of these string locating formations would be used by a pipe layer to lay a pipe. However by providing two different string locating formations on the support the pipe layer is provided with different options.

The pipe support may include a third string locating formation for attaching a string to the pipe support.

The third string locating formation may comprise at least one string attachment projection centrally positioned on the pipe holder and spaced beneath the pipe engaging formation for attaching a string thereto. The third string locating formation may project out from front and/or rear faces of the pipe holder. Further optionally the projections may be hook shaped, e.g. to retainingly engage a piece of string.

The pipe support may further include a bedding depth indicator for visually indicating when a depth of bedding, above a trench floor and beneath a pipe held by the pipe holder, is at least at a predetermined depth, e.g. to comply with a plumbing standard or plumbing best practice. It will be appreciated by a person skilled in the art that a lowest point on the pipe engaging formation corresponds to or indicates a lowest point of a pipe received in the pipe holder.

The bedding depth indicator may also indicate the depth of bedding for a plurality of different diameters of pipes, each of which can be supported by the pipe holder either on its own or with a pipe adapter.

For example the bedding depth indicator may indicate when a predetermined bedding depth for a given pipe diameter has at least been met. Further it may do this for a 100 mm pipe, an 80 mm pipe, a 65 mm pipe and also a 50 mm pipe.

The pipe support may further include a surface depth indicator for indicating when a depth of bedding between an upper surface of a pipe and a ground surface is at least a predetermined depth.

The surface depth indicator may be formed by the peg which is sized such that the upper end of the peg is a predetermined height above an uppermost surface of the pipe.

The surface depth indicator may indicate the depth of bedding, e.g. above an uppermost surface of the pipe, for a plurality of different diameters of pipes, each of which can be supported by the pipe holder either on its own or with a pipe adapter. For example, the surface depth indicator may indicate the predetermined distance above an uppermost surface of the pipe for each of a 100 mm pipe, an 80 mm pipe, a 65 mm pipe and a 50 mm pipe.

The ground engaging formation may be a spike. The peg may have a shaft, e.g. of generally cruciform cross-sectional shape between the spike and the striking formation, and the striking formation may be enlarged relative to the shaft of the peg.

At least the pipe holder may be integrally formed by injection moulding of a polymeric material. Further the peg may also be integrally formed by injection moulding of a polymeric material. Further the pipe holder and the peg may be integrally formed by injection moulding of a polymeric material.

The pipe support remains permanently attached to its associated pipe, e.g. in a covered pipe trench. Thus the pipe support is usually non-reusable and is disposed of each time it is used. A moulding operation such as an injection moulding operation is particularly suited to producing a disposable and non-reusable pipe support at reasonable cost.

According to another aspect of the disclosure there is provided a pipe support for use in supporting a pipe, comprising:

a peg having a ground engaging formation for insertion into the ground to anchor the support and a striking formation for driving the peg into the ground;

a pipe holder configured for holding a pipe of a predetermined diameter mounted on the peg such that the pipe holder is offset from the pipe holder; and

at least one pipe adapter that is removably mountable on the pipe holder that is configured to hold a pipe of smaller diameter than the pipe sized to be held by the pipe holder, thereby enabling the pipe support to be capable of holding more than one pipe size.

This way a single pipe support can be used to hold different pipe sizes rendering it versatile and facilitating a reduction in an inventory of supports that need to be kept by a pipe layer.

The pipe adapter may include an adapter mounting formation for releasably mounting the adapter on the pipe holder. The pipe adapter may further include an adapter pipe engaging formation that is configured to complement a pipe of smaller diameter than a pipe sized for said one pipe engaging formation on the pipe holder. The pipe adapter may be configured to receive the smaller diameter pipe snugly therein.

The pipe support may include a releasable attachment arrangement for releasably mounting said adapter mounting formation on said pipe engaging formation comprising complementary clip formations on each of the pipe engaging formation and the adapter mounting formation.

The peg and the pipe holder may include any one or more of the optional features of the peg and pipe holder defined in a preceding aspect of the disclosure. Further the pipe adapter and the releasable attachment arrangement may include any one or more of the features defined in a preceding aspect of the disclosure.

According to another aspect of the disclosure there is provided a pipe support for use in supporting a pipe, comprising:

a peg having a ground engaging formation for insertion into the ground to anchor the support and a striking formation for driving the peg into the ground;

a pipe holder mounted on the peg such that the pipe holder is offset from the pipe holder; and

at least one string locating formation for locating a string thereon that is used to position and orientate the pipe in the pipe holder for lining up the pipe with other pipes, e.g. to position and orientate the pipe in the pipe holder for aligning the pipe with other pipes at a certain gradient.

The pipe support may include a first string locating formation on the peg above the pipe holder, comprising a tab projecting laterally away from the peg defining a notch through which the string can be passed.

The pipe support may include a second string locating formation located on the pipe holder, for locating a string used for setting up and aligning pipe sections in a pipe.

The pipe holder may include a pipe engaging formation that is configured to engage a pipe, and the second string locating formation may comprise at least one notch or recess formed in the pipe engaging formation that is substantially centrally positioned, e.g. on the pipe engaging formation. That way the string extends along a bottom line of the pipe.

The pipe support may include a third string locating formation located on the pipe holder for attaching a string to the pipe support, comprising at least one string attachment projection projecting from the pipe holder for attaching a string thereto.

The at least one string attachment projection may be centrally positioned on the pipe holder and may be spaced beneath the pipe engaging formation for attaching a string thereto.

The pipe holder may have front and rear faces and the third string locating formation may comprise string attachment projections projecting from each of the front and rear faces.

The peg and the pipe holder may include any one or more of the optional features of the peg and pipe holder defined in a preceding aspect of the disclosure. Further the first, second and third string locating formations may include any one or more of the features of the corresponding string locating formations defined in a preceding aspect of the disclosure.

According to another aspect of the disclosure there is provided a pipe support for use in supporting a pipe, comprising:

a peg having a ground engaging formation for insertion into the ground to anchor the support and a striking formation for driving the peg into the ground;

a pipe holder mounted on the peg such that the pipe holder is offset from the pipe holder; and

a bedding depth indicator for visually indicating when a depth of bedding above a trench floor and beneath a pipe held by the pipe holder is at least at a predetermined depth.

The bedding depth indicator may indicate the depth of bedding for a plurality of different diameters of pipes, each of which can be supported by the pipe holder either on its own or with a pipe adapter.

The peg and the pipe holder may include any one or more of the optional features of the peg and pipe holder defined in a preceding aspect of the disclosure. Further the bedding depth indicator may include any one or more of the features of the corresponding bedding depth indicator defined in a preceding aspect of the disclosure.

According to another aspect of the disclosure there is provided a support for use in supporting a pipe, comprising:

a peg having a ground engaging formation for insertion into the ground to anchor the support and a striking formation for driving the peg into the ground;

a pipe holder mounted on the peg such that the pipe holder is offset from the pipe axis; and

a surface depth indicator for indicating when a depth of bedding between an upper surface of a pipe and a ground surface is at least a predetermined depth.

The peg may have an upper end, and the surface depth indicator may be formed by the upper end of the peg, the peg being sized such that the upper end is a predetermined height above an uppermost surface of the pipe.

The upper end of the peg when covered indicates that there is a predetermined depth of bedding between the upper end of the peg and the pipe for a plurality of different diameters of pipes, each of which can be supported by the pipe holder either on its own or with a pipe adapter.

Thus when the upper end of the peg is below a ground surface there is a minimum depth of bedding between pipe and surface. Conveniently the upper end of the peg may be positioned at a height of about 25 mm above an upper surface of a pipe received within the pipe holder. A depth of 25 mm is the distance or clearance required between a slab, e.g. of concrete, and a pipe positioned beneath the slab. The surface depth indicator helps to ensure that this clearance is maintained when a pipe is laid and a slab is poured over the pipe. A pipe layer could not easily leave the upper end of the peg projecting up above the ground and this provides an inducement to lay the pipe according to best practice.

The peg and the pipe holder may include any one or more of the optional features of the peg and pipe holder defined in a preceding aspect of the disclosure. Further the surface depth indicator may include any one or more of the features of the surface depth indicator defined in a preceding aspect of the disclosure.

According to yet another aspect of the disclosure there is provided a method for lining up pipes in a trench with a pre-determined fall, the method including:

placing a plurality of pipe supports within a trench with the pipe supports arranged along a pipe line, each pipe support comprising:

a peg having a ground engaging formation for insertion into the ground to anchor the support and a striking formation for driving the peg into the ground; and a pipe holder including a pipe engaging formation that is configured to engage a pipe in a way that grips the pipe and holds it in the holder while permitting the pipe to slide and rotate relative to the pipe holder;

setting the heights of each of the pipe supports so that they form a straight line with a predetermined fall;

mounting the pipes consecutively on the pipe supports in the trench, and operatively coupling the pipes to each other; and

backfilling the trench while the pipe supports remaining permanently in position in the trench holding the pipe.

The placing may include hammering the striking formation to drive the peg into the trench bottom.

The method may include an initial step of excavating a trench and forming a trench bottom and a trench side wall, wherein the setting includes precisely setting and adjusting the height of each pipe support using height measuring equipment.

During the back filling a bedding is spread over the pipes, and the pipe supports hold the pipes in position and resist moving and lifting of the pipes.

The method may include mounting a pipe adapter on the pipe support to make it suitable for receiving a pipe of smaller diameter than a pipe for which the pipe holder is configured to receive.

The setting may include setting and adjusting the height of each pipe support with a fine tolerance using height measuring equipment, e.g. a laser device.

The pipe support, peg and the pipe holder may include any one or more of the optional features of the peg and pipe holder defined in a preceding aspect of the disclosure.

The disclosure also extends to a system for lining up pipes in a trench with a pre-determined fall, the system including a pipe support as defined in accordance with any one of the preceding aspects of the disclosure; and

a pipe mounted on the pipe support whereby to hold it at a correct height when setting up a pipeline.

The pipe support may be mounted in a trench floor and the pipes may form a subterranean pipeline.

The pipe support, peg and the pipe holder may include any one or more of the optional features of the peg and pipe holder defined in a preceding aspect of the disclosure.

The disclosure also extends to a pipeline installation including a plurality of pipes each of which is mounted on a pipe support as defined in accordance with any one of the preceding aspects of the disclosure.

### BRIEF DESCRIPTION OF THE DRAWINGS

A pipe support system for supporting and lining up pipe sections in a straight line and with predetermined fall in accordance with this disclosure may manifest itself in a variety of forms. It will be convenient to hereinafter describe at least one embodiment of the disclosure in detail with reference to the accompanying drawings. The purpose of providing this detailed description is to instruct persons having an interest in the subject matter of the disclosure how to carry the disclosure into practical effect. However it is to be clearly understood that the specific nature of this detailed description does not supersede the generality of the preceding broad description. In the drawings:

FIG. 1 is an upper perspective view of a pipe support in accordance with one embodiment of the of the disclosure;

FIG. 2 is a lower perspective view from the other side of the pipe support of FIG. 1;

FIG. 3 is a front view of the pipe support of FIG. 1;

FIG. 4 is a rear view of the pipe support of FIG. 1;

FIG. 5 is a perspective view of a pipe adapter for mounting on the pipe support above the pipe support;

FIG. 6 is a front view of the adapter of FIG. 7;

FIG. 7 is a top plan view of the adapter of FIG. 7;

FIG. 8 is an upper perspective view of the pipe support of FIG. 1 having a pipe adapter for mounting on the pipe support above the pipe support;

FIG. 9 is an upper perspective view showing the adapter of FIG. 8 mounted on the pipe support in FIG. 6;

FIG. 10 is a front view of the pipe support of FIG. 1 showing a distance from a lowest point of a retained pipe to an indicator marked on the pipe holder;

FIG. 11 is a front view of the pipe support of FIG. 1 showing a distance from a lowest point of a smaller pipe retained in an adapter to another indicator marked on the pipe holder;

FIG. 12 is a front view of the pipe support of FIG. 1 showing a distance from a lowest point of an even smaller pipe received in an adapter to another indicator marked on the pipe holder;

FIG. 13 is a front view of the pipe support of FIG. 1 showing a distance from a lowest point of a yet even smaller pipe received in an adapter to an indicator marked on the pipe holder;

FIG. 14 is an upper perspective view of the pipe support of FIG. 1 holding a pipe and showing two string lines extending parallel to the pipe and located in the string holders on the pipe support;

FIG. 15 is an exploded lower perspective of the pipe support of FIG. 1 and a pipe adapter operatively coupled to a smaller diameter pipe before the adapter is clipped onto the pipe holder; and

FIG. 16 is a schematic side elevational view of a pipe support received in the ground where it is holding the pipe adapter and pipe of FIG. 15.

### DETAILED DESCRIPTION

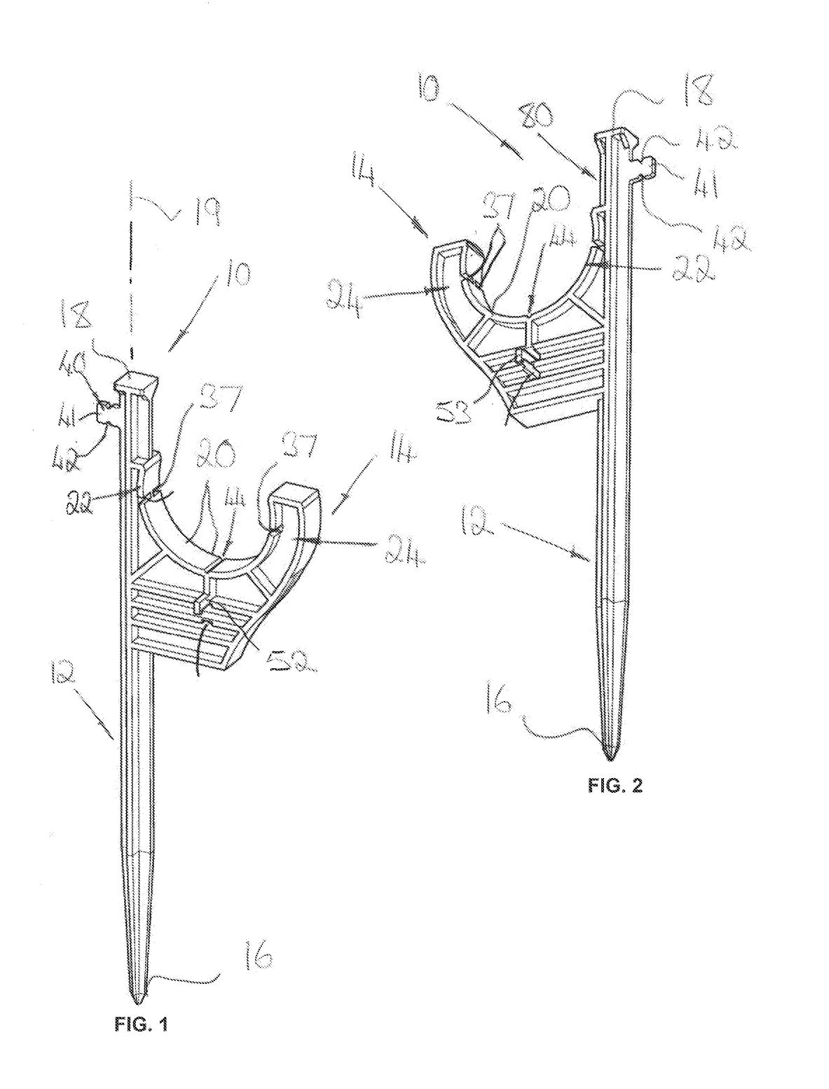

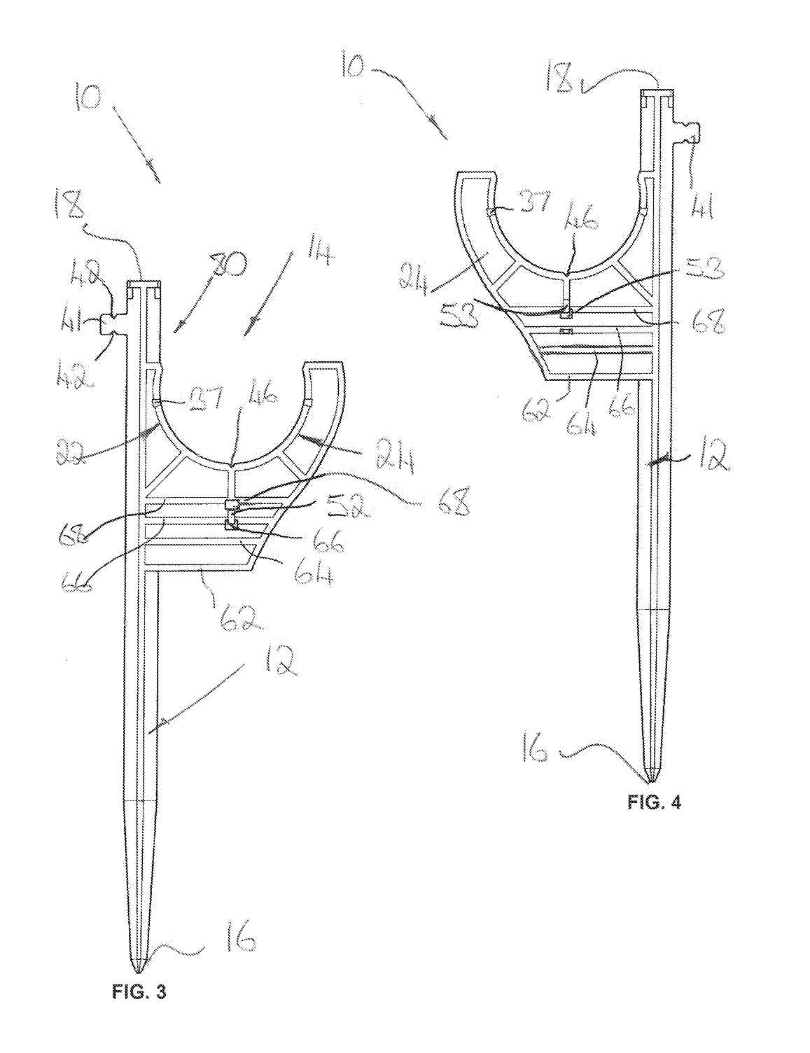

In FIG. 1 reference numeral 10 refers generally to a pipe support in accordance with the disclosure.

The pipe support 10 comprises broadly a peg 12 and an offset pipe holder 14 mounted on the peg 12. Each of the peg 12 and the pipe holder 14 will now be described in more detail.

The peg 12 has a ground engaging formation in the form of a spike 16 at its operatively lower end for insertion into the ground to anchor the pipe support 10. The peg 12 also a striking formation 18 at its operatively upper end that is enlarged relative to the cross section of the shaft of the peg 12. The peg 12 has a shaft between the ground engaging formation 16 and the striking formation 18 that optionally has a cruciform cross-sectional shape. The peg 12 also has a longitudinal axis 19 extending between the spike 16 and the striking formation 18 so that a hammer strikes the striking formation on the same line as the spike 16. The striking formation 14 is orthogonal to the longitudinal axis 19 of the peg 14 so that it is particularly suitable for striking with a hammer to drive the peg 12 into the ground.

The offset pipe holder 14 projects laterally away from the peg transverse to the longitudinal axis 19 of the peg 12. The pipe holder 14 has front and rear faces 15 and 17 and includes a pipe engagement formation 20 that is configured to engage a pipe in a way that grips and holds the pipe while permitting the pipe to slide and rotate relative to the pipe holder 14. The pipe engagement formation 20 has a curvilinear configuration to complement the cylindrical wall of the pipe to be held therein and is resiliently flexible to enable it to be deformed to receive and then grip a received pipe.

For example the curvilinear pipe engagement formation 20 may comprise two arcuate forms 22 and 24, e.g. in the form of arms, that extend upward to terminal ends that are spaced apart from each other. The arcuate forms 22, 24 are configured to complement the cylindrical wall of the pipe to be held therein and the terminal ends of the arcuate forms 22 and 24 are spaced a distance apart such that a pipe to be held can be passed there between with some deformation of the forms 22 and 24. The spacing of the terminal ends is designed to urge against the pipe being held and grip the pipe when the arcuate forms 22, 24 return towards their resting form. In the illustrated embodiment the two arcuate forms 22 and 24 together extend more than one half circle, in a C-shape, to provide for the retention discussed above. In particular the pipe engagement formation 20 may be sized to receive a 100 mm diameter pipe therein. This size of pipe is typically used for waste water pipes leading from a structure to a sewerage main.

The pipe support 10 further includes a plurality of pipe adapters 30 that can be selectively mounted on the pipe holder 14 as required. This is done to enable the pipe support 10 to accommodate holding pipes of different diameters to that for which the pipe engaging formation 20 is sized.

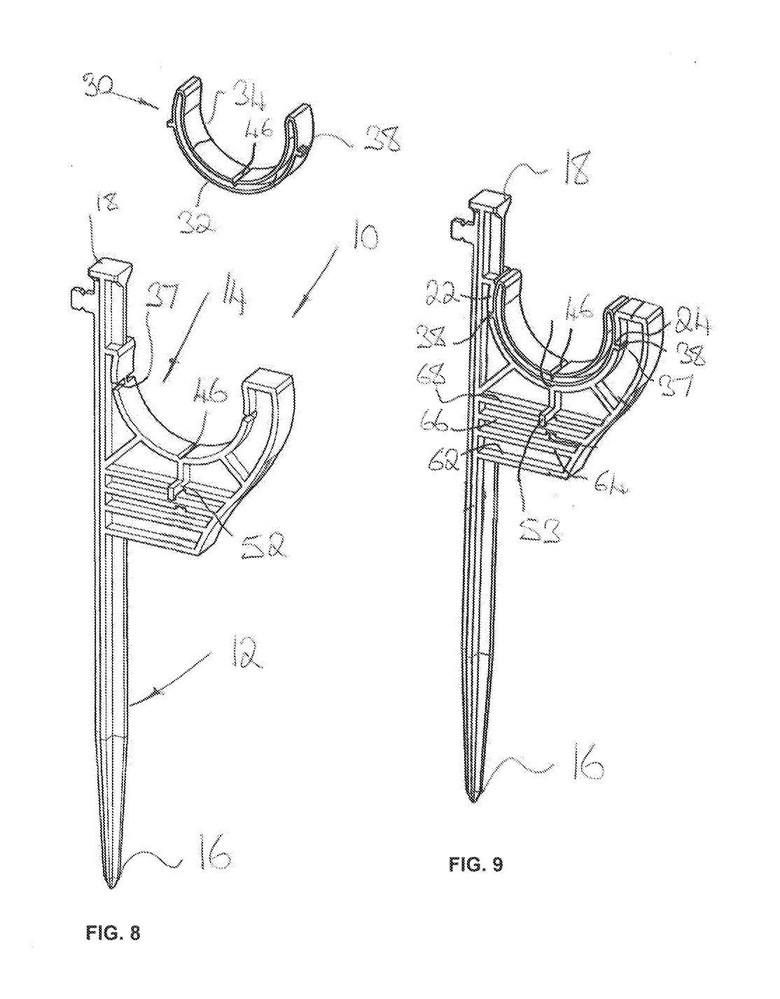

One example pipe adapter 30 is shown in FIGS. 7 to 9. The pipe adapter 30 comprises generally an adapter mounting formation 32 that is configured to engage the pipe engaging formation 20 of the pipe holder 14 on which it is mounted and an adapter pipe engaging formation 34 for engaging a pipe received therein. The adapter mounting formation 32 may comprise a semi-circular arcuate form that complements and lies up against the pipe engaging formation 20. The adapter pipe engaging formation 34 is very similar to the curvilinear pipe engaging formation 20 on the pipe holder 14. That is it includes two arcuate forms 35 and 36 that resemble left and right arms that extend upward to spaced terminal ends between which a pipe can be inserted.

The pipe holder 14 further include a releasable attachment arrangement for releasably mounting the pipe adapter 30 on said pipe engaging formation 20. The releasable attachment arrangement comprises complementary attachment formations 37 and 38 in the form of releasable clip formations on each of the pipe holder 14, e.g. the pipe engaging formation 20 thereof, and the pipe adapter 30.

As shown in FIGS. 7 to 9 the adapter 30 overall has a C-shaped form. It has a web section linking inner and outer C-shaped walls to each other a spaced distance apart. Further the complementary attachment formation comprises two spaced clip formations 38 projecting away from the outer wall. It also has a recess forming a string locating formation as will be described in more detail below.

Conveniently the pipe holder 14 and the peg 12 are integrally formed, e.g. by injection moulding of a polymeric material. By suitable choice of polymeric material this confers the resilient flexibility that is required to receive the pipe and also releasably attach it to an adapter 30. The adapters 30 are also conveniently separately moulded of polymeric material. The polymeric material provides of some resilient flexibility that is required to receive the pipe and also engage the pipe holder 14. Further the overall shape of both the pipe holder 14 and the adapter 30 also assists in conferring this resilient flexibility.

In the illustrated embodiment the pipe support 10 includes three different sizes of pipe adapters for use with the support 10. Each of the adapters 30 can be releasably mounted to the pipe holder 14 for supporting different diameter pipes. For example these pipe adapters 30 may be sized to receive respectively a 80 mm pipe, a 65 mm pipe and a 50 mm pipe. This covers many of the typical sizes of piping used by plumbers in municipal and domestic waste water plumbing systems.

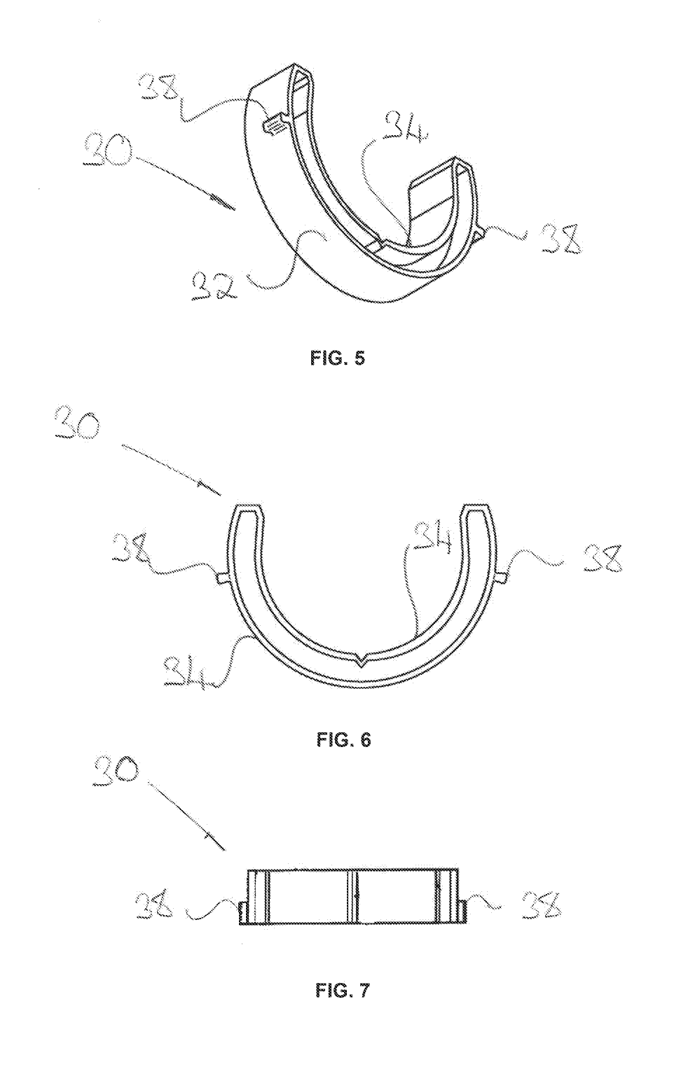

FIGS. 5 and 6 illustrate the adapter 30 of FIGS. 7 to 9 being mounted on the pipe engaging formation 20 of the pipe holder 12. The adapter 30 is orientated so that its adapter mounting formation 32 is matched with the pipe engaging formation 20. The adapter 30 is then clipped onto the pipe holder 14 by engagement of clip formations 37, 38 with the adapter pipe engaging formation 34 facing upward for receiving a pipe of complementary size.

The pipe support 10 further includes several string locating formations for locating a string for setting up and aligning pipe sections in a pipe.

A first string locating formation 40 is located on the peg 12 at a height above the pipe holder 14. The first string locating formation 40 is located on an opposite side of the peg 12 to the pipe holder 14. In the drawings the first string locating formation 40 comprises a tab 41 projecting laterally away from the peg defining a notch 42 through which the string can be passed.

A second string locating formation 44 is located on the pipe holder 14 and is formed by a notch or recess 46 on the pipe engaging formation 20. In the illustrated embodiment the notch or recess is centrally positioned on the pipe engaging formation 20. The second string locating formation also includes a notch or recess 46 on the adapter 30 that is very similar to the corresponding notch or recess 46 on the pipe engaging formation. In particular the recess 46 is centrally positioned on the adapter pipe engaging formation 34.

A third string locating formation shown generally by numeral 48 is also located on the pipe holder 14 for attaching an end of a string thereto. The third string locating formation 48 comprises string attaching projections 52 and 53 projecting away from front and rear faces 15 and 17 of the pipe holder 14. The projections 52 and 53 can be used to fix an end of a string thereto when the string is passed through the notch recesses 46 of a line of pipe supports 10.

The pipe support 10 also includes several visual indicators for indicating certain key distances to a plumber or pipe installer. The pipe support 10 includes a bedding depth indicator 60 for indicating a depth of bedding between a trench floor and a bottommost surface of a pipe. The bedding material may be gravel, screed, dirt, or other suitable materials or a mix of those materials and is different from surrounding earth. The bedding depth indicator 60 enables an installer to easily determine whether or not design requirements or plumbing standards have been met relating to the depth of a bedding beneath the pipe. The bedding depth indicator 60 may comprise several indicia on the pipe holder for indicating when a standard depth of bedding is attained for different pipe diameters.

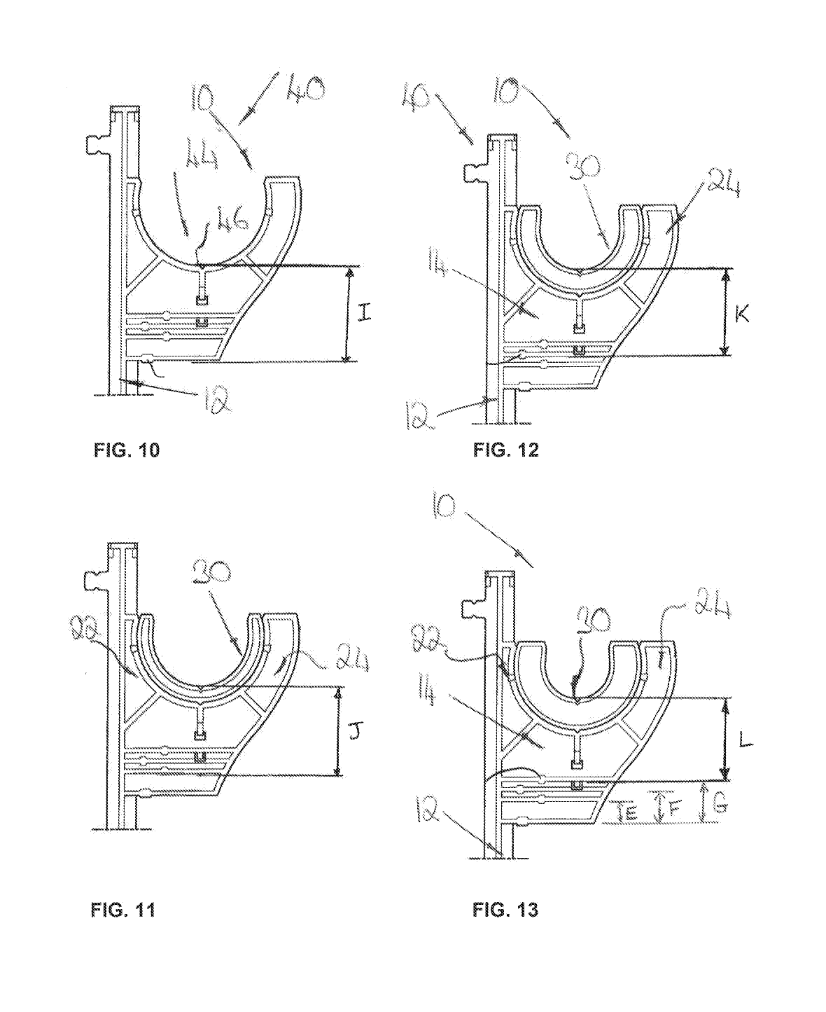

FIG. 10 shows the bedding depth I between an indicium 62 on the front face of the holder 14 and a central position on the pipe engaging formation 20 where a bottom-most surface of a 100 mm diameter pipe would be located when received in the pipe holder 14. In this embodiment, the bedding depth I is 75 mm. Similarly, FIG. 11 shows the bedding depth J between an indicium 64 on the front face 15 of the holder 14 and a central position on the adapter pipe engaging formation 34 where a bottom-most surface of an 80 mm diameter pipe would be located when received in the pipe holder 14. The bedding depth J is 75 mm FIG. 12 shows the bedding depth K between an indicium 66 on the front face 15 of the holder 14 and a central position on the adapter pipe engaging formation 34 where a bottom-most surface of a 65 mm diameter pipe would be located when received in the pipe holder 14. The bedding depth K is 75 mm.

FIG. 13 shows the bedding depth L between an indicium 68 on the front face 15 of the holder 14 and a central position on the adapter pipe engaging formation 34 where a bottom-most surface of a 50 mm diameter pipe would be located when received in the pipe holder 14. Once again the bedding depth is maintained at 75 mm Thus it will be appreciated that the bedding depth indicator 60 is able to indicate a bedding depth of at least 75 mm to an installer irrespective of the diameter of pipe that is being laid. FIG. 13 also shows the separation or spacing E between the indicium 62 and indicium 64 which is 13.7 mm, the separation F between indicium 64A and 66 which is 24 mm, and the separation G between indicium 66 and indicium 68 which is 27 mm.

In the illustrated embodiment, the indicia 62, 64, 66 and 68 may be marked with numbers representing the diameters of the pipes related to the particular indicium. For example, the indicium 62 can be marked as “100”, indicium 64 may be marked a “80”, indicium 66 may be marked as “65” and indicium 68 may be marked as “50”. It will be understood that the indicia can be written in all sorts of ways so as to convey adequate meaning to a user of the pipe support 10. The indicia can be printed, or embossed into or onto the pipe support. The indicia may also be integrally formed with the pipe holder when it is formed by a moulding process.

Yet further the pipe support 10 includes a surface depth indicator 80 for indicating a minimum depth between a ground surface and an uppermost region of a pipe. Plumbing standards and design practices often require that there is a minimum depth of soil of bedding between the ground surface and an uppermost region of a pipe. The surface depth indicator 80 provides a visual indicator to an installer of whether this has been met.

In particular the surface depth indicator 80 is formed by configuring and sizing the peg 12 such that the striking formation 18 at an upper end of the peg 12 indicates a certain distance between an uppermost surface of a received pipe and the upper end. By setting this distance at a minimum required depth, the distance or depth between the ground surface (external to the excavation) and the top of the peg provides a useful depth indicator to an installer or pipe layer. For example in the illustrated embodiment when the upper end or top of the peg 12 is aligned with the ground surface the depth of bedding between the surface and the pipe may be about 25 mm. Further for an 80 mm pipe, a 65 mm pipe or a 50 mm pipe it may also be set at a surface depth of about 25 mm. The person skilled in the art will readily appreciate that by lengthening the height of the peg above the pipe holder 14 the depth of surface bedding indicated by the surface depth indicator 80 could be increased to any desired value, e.g. 50 mm or 100 mm Applicant appreciates that different applications may require different depths for the pipe beneath the ground surface.

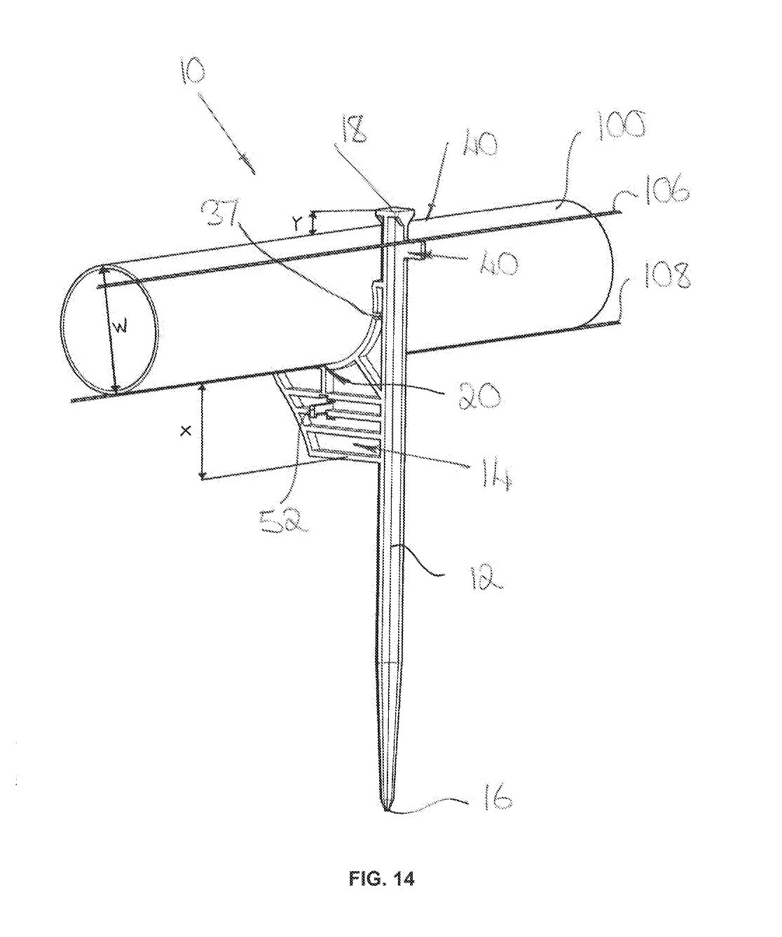

In FIG. 14 a pipe 100 which is mounted on the pipe support 10 is a 100 mm diameter pipe and thus an adapter 30 is not required to adjust the pipe engaging formation 20 to snugly receive the pipe 100.

The diameter of the pipe 100 is indicated by W. The vertical separation between the bottom-most edge or surface of the pipe 100 and the indicium A is marked by X. The distance X in this example is 75 mm, reflecting the distance between the bottom-most edge of the pipe 100 and the trench bottom being the ground into which the peg 12 is inserted. A distance Y represents a vertical height or distance between a topmost or uppermost point or surface of the pipe 100 and the upper end of the peg 12. The distance Y is an indication of the height of the upper layer of bedding above an uppermost point or surface of a pipeline. During installation of the pipe an upper layer of bedding is placed over the pipeline 100, such that, if the upper layer of bedding just meets or minimally covers the upper end of the peg 12, this visually indicates to a pipe layer that a sufficient depth of bedding has been placed over a top of the pipeline. In the illustrated embodiments, a distance Y between an uppermost point of a pipe and upper end of the peg 12 is the same distance for all diameters of pipes. This uniformity across different diameter pipes is achieved by tailoring a depth or thickness of the adapters 30 so as to account for the different diameters of pipe. It will readily be appreciated that this feature confers significant working advantage. For some standards, distance Y is 25 mm, whereas other standards may prescribe a greater depth.

FIG. 14 also shows two string lines 106 and 108 extending along a length of the pipe and operatively fixed to the string locating formations 40 and 44. The string line 106 is engaged with the top notch 42 of the string line locating formation 40. By contrast the string line 108 is engaged with string line locating formation 44 centrally positioned on the pipe engaging formation 20. As is clear from the drawings the lines 106 and 108 extend parallel to the pipe 100. An advantage of having two parallel string lines 106 and 108 is that it helps to line up the pipe sections 100 forming a pipe in a straight line with a correct gradient or fall.

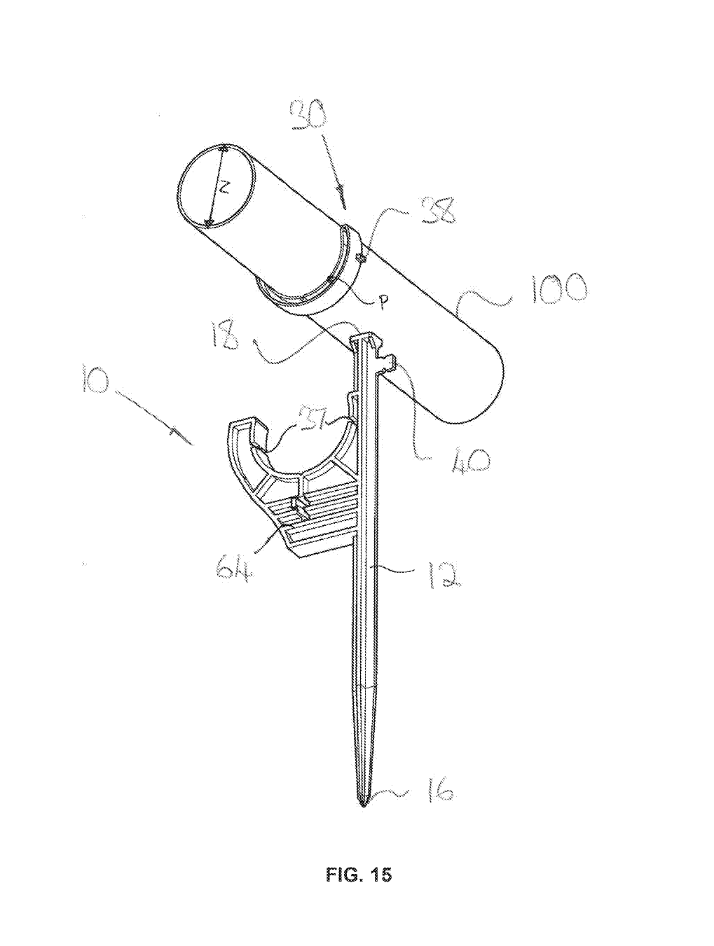

FIG. 15 shows an embodiment of the pipe support 10 where the adapter 30 is mounted on the support 12 and a pipe 100 is received within the adapter pipe engaging formation 34 of the adapter 30. The pipe 100 in FIG. 15 is a smaller diameter pipe than the pipe shown in FIG. 14, e.g. the pipe diameter Z may be 65 mm. Further the radial width or height P of the insert 18 may be 35 mm to compensate for this reduced diameter as discussed above.

In use, an adapter 30 is selected for the known pipe 100 according to its diameter. The adapter mounting formation 32 is mounted to the pipe engaging formation 20 of the pipe holder 14, and then the peg 12 of the pipe support 10 is driven into the ground to the point indicated by the respective indicium for the selected insert, e.g. an 80 mm pipe. The pipe 100 can be placed on the series of pipe supports 10, and, if required, snapped into each adapter 30 for each respective pipe support.

In an alternative use scenario, the adapter 30 is first snapped on to the pipe 100 and then the adapter 30 can be slid relative to the pipe support 10 to engage the complementary engagement formations 37 and 38 on respectively the pipe engagement formation 16 and the adapter 30. In this alternative scenario the pipe support 10 has already been inserted into the ground before the adapter 30 and pipe 100 are mounted on the pipe support 10.

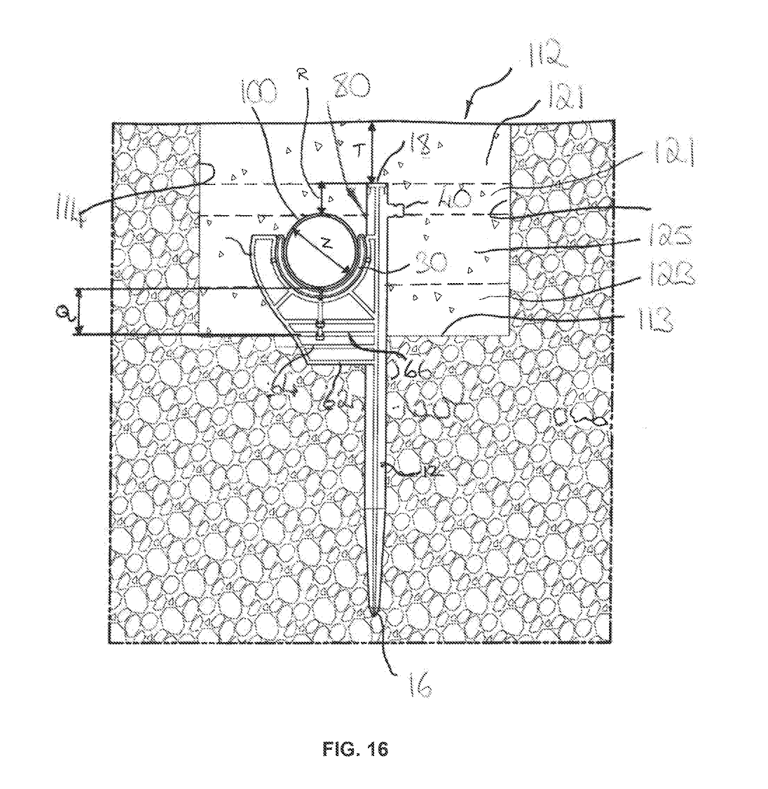

FIG. 16 is a schematic rear elevation of another embodiment of the disclosure showing the pipe support and pipe received in a trench 112.

In use when installing a pipe, as a first step the trench 112 is excavated. The trench is typically excavated using an excavating machine and has a trench bottom 113 beneath the ground surface and trench walls 114 extending along each side of the trench 112. The width of the trench 112 between opposing sides of the trench wall 114 will be sufficient to accommodate the pipe support 10 and the pipe 100. This may be determined by the pipe layer or plumber according to convenience and/or practicality.

In use, a plurality of pipe supports 10 are used to support a pipe in a trench that has been excavated in the ground. The pipe supports 10 are arranged in a line along the length of the planned pipe. Each pipe support 10 is positioned at a specific point along the length of the pipe. By setting each pipe support 10 at a specific height corresponding to the design height of the pipe at that point, the supports 10 can be used to precisely support pipe sections of the pipe in a straight line with the correct slope and gradient.

The individual pipe supports 10 are set at their correct heights using height sensing equipment such as laser levels or the like. Thereafter pipe sections can be mounted on the pipe supports 10 where they are engaged by the pipe engaging formation 20. The pipe sections can then be operatively coupled to each other, e.g. by solvent welding adhesive or the like. The act of coupling the pipes to each other may involve sliding or rotating the pipes in the pipe holder 14 and the pipe holder 14 is designed to facilitate this action without having to detach the pipes that are being coupled from their pipe holders 14.

A pipe support 10 is operatively connected to an adapter 30 and pipe 100 that is of smaller diameter than the pipe shown in FIG. 16. The pipe support 10, the adapter 30, and the smaller diameter pipe 100 are received in the trench 112. The peg 12 and part of the pipe holder 14 are received in ground on the trench bottom 113.

During installation the pipe support 10 is inserted into the ground 110 at the bottom of the trench 116 to a depth indicated by indicium, as the diameter of the pipe Z is 65 mm. The vertical distance Q between the ground 110 at the bottom of the trench 116 and the bottom-most edge of the pipe 100 will then be a pre-determined separation, which in this embodiment is 75 mm, being the height of the lower layer of bedding 123.

In alternative scenarios (say, where the ground is very hard), the peg is placed in the ground and the level of the ground is raised by using more soil or other material to the level indicated by the indicium. In yet another scenario, the indicia below the relevant indicium can be cut off or otherwise removed so that the pipe support can be easily inserted into the ground to the correct level.

In the trench 112 there is a bedding profile including the upper layer of bedding 121, a lower layer of bedding 123 and a middle layer of bedding 125. There may be standard requirements for the heights of the upper layer of bedding 121 and the lower layer of bedding 123. The height of the middle layer of bedding 125 will typically be the same as the pipe diameter. The bedding material used for the bedding may be gravel, screed, dirt, or other suitable materials or a mix of these materials.

FIG. 16 also shows the vertical separation R between the top-most edge of the pipe 100 and the upper end of peg 12. As previously mentioned, this indicates the minimum depth to which the pipe should be buried under the upper layer of bedding 121.

In FIG. 16 the back-fill 120 has been filled so as to be levelled with the ground surface 118 adjacent the top of the trench, at a vertical separation T between the upper end of the peg 12 and the back-fill surface 122.

An advantage of the embodiment described above with reference to the drawings is that once a trench is excavated it helps with an initial set up of pipe sections so that they extend in a straight line at a required or design gradient or fall. The pipe supports are located at spaced intervals along the length of the pipe and locate discrete pipe sections at a specific height in their specific positions along the length of the pipe. Survey equipment such as laser levels may be used to set the heights of the individual pipe supports.

A further advantage of the embodiment described above is that the pipe supports hold the discrete pipe sections very accurately in their correct positions determined by survey. The pipe support with peg allows for very fine adjustment of the height of the support and thereby provides for high tolerance positioning of the pipe sections in the trench. Another important advantage of the pipe support described above is that it does more than vertically support the pipe in a certain position. Rather it positively grips and holds the pipe very securely and firmly in position. This is important because resists the pipe from moving off the required grade or out of alignment with adjacent pipe sections during installation of the pipe.

A related advantage of the pipe support is that it enables a plumber to slide and rotate a pipe section relative to the support, e.g. for operatively coupling two adjacent pipe sections to each other by solvent welding or the like. This enables a pipe to be installed more easily and quickly without disturbing the height setting of the pipe support.

Yet further retention of the pipe in position when backfilling occurs is very important. For example the pipe is prone to shifting or bowing when soil is backfilled into the trench. However the structure of the pipe support 10 and the manner in which it grips and holds the pipe resists this. Similarly in wet ground conditions where there is a risk of the pipes floating up or being lifted by the water the pipe holder 14 physically retains and holds the pipe at the required height.

A related advantage of the pipe support is that the pipes are no longer rested on the trench floor and the height of the pipe is effectively made independent of the slope and accuracy of the initial excavation and sloping of the trench floor. Provided each of the pipe supports is set at a correct or predetermined height and the details of the trench base become largely unimportant. This is turn can lead to cost savings in digging the trench because it no longer has to be done carefully with a fine tolerance having regard to the importance of the height and slope of the trench floor.

Another problem with previous pipe supports is that they are made to support only one diameter of pipe. However in different applications, there may be requirements to use different diameter pipes even in the same pipeline. It is inconvenient to stock a variety of pipe supports, each support being adapted for supporting a different diameter pipe. Further, it can be expensive to manufacture different sized pipe supports and a pipe layer has to keep perhaps four or five different types of pipe support in stock to allow or for laying of the different diameter pipes.

A significant advantage of the pipe support described above is that it can receive adapters for different sizes of pipes. For example the pipe support without adapter can be sized to receive a pipe having a nominal diameter of 100 m. A first pipe adapter can be configured to snugly and tightly hold a pipe of 80 mm diameter and further adapters can be configured to hold pipes of 65 and 50 mm respectively. Each of the adapters is a separate component that can be clipped onto the pipe engagement formation and thereby render the support suitable for holding a correspondingly sized pipe. The obvious advantage of this feature is that a single pipe support can be used to hold several different sizes of pipes with equal efficacy. With an appropriate supply of adapters an inventory of pipe supports that needs to be carried can be reduced. Further if an installer or pipe layer decides to change the size of pipes being used after the initial set up with pegs and string lines they can do so without having to reset the pegs and string lines. Once again this saves time and also saves cost.

Another advantage is that the striking formation on the peg is the highest point on the pipe support thereby providing generous clearance from other structures to ease hammering of the peg into the ground. Yet further the striking formation is vertically aligned with the ground engaging formation which helps to drive the peg firmly into the ground, bearing in mind that secure anchoring of the peg is of paramount importance in the implementation of this disclosure.

The pipe support has string locating formations for facilitating a string line being run along the length of the pipe parallel to the pipe. By integrating this into the construction of the pipe support, it is reproduced at exactly the same height on each support and this helps to correctly lay out the pipe sections for installation. Yet further the illustrated pipe support has string locating formations in different positions on the pipe support. This provides different options for a plumber laying a pipe. For example the first string locating formation on a side of the peg can be used for initial lay out in an excavated trench. The other string locating formation centrally adjacent to a bottom of a pipe received in the support can be used to closely align the pipe sections when mounted on the pipe supports. Further the string line attachment formations illustrated in the drawings include a notch recess to positively locate the string and resist it from moving around.

It will of course be realized that the above has been given only by way of illustrative example of the disclosure and that all such modifications and variations thereto, as would be apparent to persons skilled in the art, are deemed to fall within the broad scope and ambit of the disclosure as is herein set forth.

1. A pipe support for use in lining up a pipe with a fall, the pipe support, comprising:
a peg having a ground engaging formation for insertion into the ground to anchor the support and a striking formation for driving the peg into the ground;
a pipe holder mounted on the peg such that the pipe holder is offset from the peg, the pipe holder including a pipe engaging formation that is configured to engage a pipe in a way that grips the pipe and holds it in the holder while permitting the pipe to slide and rotate relative to the pipe holder; and
at least one pipe adapter that is removably mountable on the pipe holder and that is configured to hold a pipe of smaller diameter than a pipe of said predetermined diameter whereby to render the pipe support capable of supporting pipes of different diameters.

2. A pipe support according to claim 1, wherein the peg has an axis extending between the ground engaging formation and the striking formation, and the striking formation is formed by an upper end of the peg, and the pipe holder has front and rear faces and projects away from the peg transverse to the axis.

3. A pipe support according to claim 1, wherein the pipe engaging formation is curvilinear and is configured to complement a pipe of a predetermined diameter for snugly receiving the pipe therein.

4. A pipe support according to claim 3, wherein the pipe engaging formation is resiliently flexible and comprises two arcuate forms that extend upwardly to terminal ends that are spaced apart from each other, and the arcuate forms can be flexed to enable a pipe to be passed between the terminal ends to receive the pipe.

5. A pipe support according to claim 4, wherein the two arcuate forms extend through more than a full semi-circle or half circle and angle towards each other at their terminal ends for providing actual retention of a pipe engaged with the pipe engaging formation.

6. A pipe support according to claim 1, wherein the pipe adapter further includes an adapter mounting formation for releasably mounting the adapter on the pipe holder, and an adapter pipe engaging formation that is configured to receive a small diameter pipe than the pipe received by said one pipe engaging formation.

7. A pipe support according to claim 6, including a releasable attachment arrangement for releasably mounting said adapter mounting formation on said pipe engaging formation, comprising complementary clip formations on each of the pipe engaging formation and the adapter mounting formation.

8. A pipe support according to claim 7, wherein the complementary clip formations comprise two spaced male formations on the adapter mounting formation and two complementary female formations on the pipe engaging formation of the pipe holder.

9. A pipe support according to claim 1, further including at least one string locating formation for locating a string thereon that is used to position and orientate the pipe in the pipe holder for lining up a plurality of pipes.

10. A pipe support according to claim 9, including a first string locating formation located on the peg above the pipe holder, the first string locating formation comprising a tab projecting laterally away from the peg defining a notch through which the string can be passed, and wherein the pipe holder is positioned on one side of the peg and the tab is positioned on an opposed side of the peg.

11. A pipe support according to claim 9, including a second string locating formation located on the pipe holder, for locating a string used for setting up and aligning pipe sections in a pipe, wherein the second string locating formation comprises at least one notch or recess that is substantially centrally positioned on the pipe engagement formation.

12. A pipe support according to claim 9, including a third string locating formation for attaching a string to the pipe support, comprising at least one string attachment projection centrally positioned on the pipe holder spaced beneath the pipe engaging formation for attaching a string thereto.

13. A pipe support according to claim 1, further including a bedding depth indicator for visually indicating when a depth of bedding above a trench floor and beneath a pipe held by the pipe holder is at least at a predetermined depth.

14. A pipe support according to claim 13, wherein the bedding depth indicator indicates the depth of bedding for a plurality of different diameters of pipes, each of which can be supported by the pipe holder either on its own or with a pipe adapter.

15. A pipe support according to claim 2, further including a surface depth indicator for indicating when a depth of bedding between an upper surface of a pipe and a ground surface is at least at a predetermined depth.

16. A pipe support according to claim 15, wherein the surface depth indicator is formed by the upper end of the peg, the peg being sized such that the upper end is a predetermined height above an uppermost surface of the pipe whereby to indicate that there is at least a predetermined depth of bedding between the upper end and the pipe.

17. A method for lining up pipes in a trench with a fall, the method including:
placing a plurality of pipe supports within a trench with the pipe supports arranged along a pipe line, each pipe support comprising:
a peg having a ground engaging formation for insertion into the ground to anchor the support and a striking formation for striking the peg to drive it into the ground; and a pipe holder including a pipe engaging formation that is configured to engage a pipe in a way that grips the pipe and holds it in the holder while permitting the pipe to slide and rotate relative to the pipe holder;
setting heights of each of the pipe supports so that they form a straight line with a predetermined fall;
mounting the pipes consecutively on the pipe supports in the trench, and operatively coupling the pipes to each other; and
back filling the trench with the pipe supports remaining permanently in position in the trench holding the pipe.

18. A method for lining up pipes in a trench according to claim 17, wherein the placing includes hammering the striking formation to drive the peg into the trench bottom.

19. A method for lining up pipes in a trench according to claim 17, including an initial step of excavating a trench forming a trench bottom and a trench side wall, and wherein the setting includes precisely setting and adjusting the height of each pipe support, and wherein during the back filling a bedding is spread over the pipes and the pipe supports hold the pipes in position and resist moving and lifting of the pipes.

20. A method for lining up pipes in a trench according to claim 17, including mounting a pipe adapter on the pipe support to make it suitable for receiving a pipe of smaller diameter than a pipe size which the pipe holder is configured to receive.
